(19) United States
(12) Patent Application Publication
(10) Pub. No.: US 2016/0167624 A1
(43) Pub. Date: Jun. 16, 2016

(54) ELECTRICALLY HEATING WINDSHIELD WASHER FLUID SYSTEM

(71) Applicant: Jere Rask Lansinger, Camano Island, WA (US)

(72) Inventor: Jere Rask Lansinger, Camano Island, WA (US)

(21) Appl. No.: 14/971,142

(22) Filed: Dec. 16, 2015

Related U.S. Application Data
(60) Provisional application No. 62/092,519, filed on Dec. 16, 2014.

(51) Int. Cl. B60S 1/48; B60S 1/46

(52) U.S. Cl. CPC B60S 1/488; B60S 1/46

(57) ABSTRACT

An electrically powered windshield wiper fluid heater having a housing with an inlet and an outlet. A piston is movably mounted in the housing between a retracted and an extended position and the piston forms a thin annular passageway between the housing and the piston. During fluid flow from the inlet, through the annular chamber and to the outlet, the differential pressure moves the piston to its extended position thus closing a switch which powers a heating element disposed around the housing.

### CROSS-REFERENCE TO RELATED APPLICATIONS

This application claims priority of U.S. Provisional Application Ser. No. 62/092,519 filed Dec. 16, 2014, the contents of which are incorporated herein by reference.

### BACKGROUND OF THE INVENTION

I. Field of the Invention

The present invention relates to electrically heated windshield wiper washer systems which can also provide nozzle freeze protection.

II. Description of Related Art

There are many situations, especially in northern or colder climates, in which it is highly desirable to heat the windshield washer fluid in an automotive vehicle and provide nozzle freeze protection. In particular, if the windshield washer fluid is heated instantly, substantially and continuously upon spraying, the washer fluid can quickly melt and clear frost and ice on the windshield and wiper blades thereby quickly providing safe driving visibility to the vehicle driver.

Due to increasing viscosity of alcohol anti-freeze containing washer fluid at subfreezing temperatures, particularly below 0° F., and especially with the higher alcohol concentrated “deicer” fluids, washer jet flow velocity is substantially reduced from flow in warm weather and results in poor fluid distribution and clearing of the windshield. Indeed, washer fluid flow is known to decrease by as much as 50% to 75% at commonly experienced temperatures below 0° F., thereby seriously inhibiting the ability of the washer system to quickly and safely clear the windshield of dried salt, dirt, frost, and ice.

There have been previously known heated windshield washer fluid systems for the primary purpose of enhancing cold weather washer wiper system deicing and cleaning performance. Many of those systems utilize the warm engine coolant of an internal combustion engine (“ICE”, in automotive vernacular) to heat the washer fluid. While at least one previously known washer heater utilizing the engine coolant to heat the fluid has proven successful in use with a pre-warmed engine, it has a significant time delay to heat up the fluid upon a substantially subfreezing cold engine start when, before driving away, it is frequently necessary to clear frost and ice on the windshield and wiper blades. Often it takes 5 minutes or more on a cold engine startup for the ICE to warm up enough for the coolant to heat the washer fluid sufficiently so the washer fluid can quickly melt windshield and wiper frost and ice, and, in more extreme cold, when nozzles are more prone to freezing partially or totally shut, regain an effective washer spray velocity and distribution onto the windshield. Consequently, while this system provides a much more rapid windshield clearing of ice and snow than with conventional warm air defrosters without the washer heater, the time to device the windshield still remains significant to drivers who are anxious to start driving upon starting a cold engine but have to contend with poor windshield visibility and washer and wiper blade function due to frost and ice buildup on the windshield and wiper blades and frozen nozzles.

A still further disadvantage of the previously known windshield washer fluid heating systems which utilize engine coolant is that such systems can only be used with internal combustion engines. Increasingly automotive vehicles are becoming all-electric motor propelled or hybrid ICE-electric propelled which only utilize the internal combustion engine as a backup motor. These vehicles that don't use an ICE upon cold vehicle start cannot use engine coolant to heat the windshield washer fluid, and instead, use electric heaters to warm the cabin air for windshield defrosters. This process of warming inside cabin air to heat up a typical 30-40 pound glass windshield before clearing the outside frost and ice on the windshield is a very thermally inefficient defrosting process, even for conventional ICE coolant heat based defrosters, when compared to immediately and aggressively electrically heating and spraying the washer fluid over a short time, e.g. 30 seconds or less, and applying it directly onto the outside ice on the windshield.

Fortunately, out of the rapidly advancing electric and hybrid vehicle technology, and particularly the more recent cost effective fuel efficiency enhancing “micro-hybrid” “stop-start” technologies, now predicted to be on the majority of ICE and hybrid vehicles built within the next few years, there are major improvements in battery, alternator, and charging technologies that finally provide a practical electric power source for a high wattage instant electric washer fluid heater that can be used on all automotive vehicles. This washer heating/cleaning technology can also be readily applied to rear windows, headlamps, backup camera lenses, object proximity and radar sensors etc. Electric charging systems having alternators in excess of 200 amps/2500 watts output, combined with batteries having higher energy storage, deeper discharge capability, higher durability, and having absorbent glass mat “AGM” “thin plate technology”, for example, are becoming quite available to power washer heaters in excess of 3000 watts continuous heating power for as much as 1 minute at a time. Many ICE vehicles are now equipped with dual advance technology batteries, and even dual alternators, which provide a very large increase in electric power source and are much in keeping with present competitive practice of “electrification of the vehicle”. The now feasible high power electric washer heater invention described herein, designed to heat with 3000 watts to 5000 watts instantly and continuously for, say, 20 to 30 seconds, or more if necessary, poses to be an order of magnitude advance in defrosting/deicing technology compared to previous electric washer heater systems and conventional warm air defrosters. Historically unsuccessful electric washer heater systems typically sprayed washer fluid intermittently for only 2 or 3 seconds, then heated a replacement 2 or 3 seconds spray amount of fluid for about 30 seconds, before spraying again, with 600 watts “recovery” heating of 2 ounces of fluid between sprays over a 2-3 minute “deicing cycle”. This often gave poor deicing performance and energy use even when working according to design intent. Indeed, the process was so slow that washer fluid refreeze on the windshield would occur between the sprays while waiting for the next 2-3 second shot of heated fluid. Furthermore when these heaters were put into extended periods of “standby” heating mode, e.g. 2 hours, at 220 watts, they would use far more energy, about 10 to 30 times more indicated here, than the present invention using short bursts of intense, 3000 watt, energy for 10 to 30 seconds.

Recent NATIONAL HIGHWAY TRAFFIC SAFETY ADMINISTRATION (NHTSA) announcements of CRASH AVOIDANCE and PEDESTRIAN PROTECTION standards to be additionally imposed upon automakers, along with the long standing CRASH WORTHINESS standards, starting in 2019 will cause automakers to seek new technology crash avoidance and pedestrian protection features such as offered by the invention herein. NHTSA indicates even the best vehicles with present day 5 star ratings in crashworthiness would do no better than 3 star rating for upcoming crash avoidance. It is difficult to conceive of any vehicle feature that could be more important regarding crash avoidance and pedestrian protection than having good windshield visibility, particularly at night.

When undertaking an electrically powered washer heater design that will be extraordinarily effective for clearing windshield ice, fundamental real world heating energy requirements need to be carefully considered in order to understand real world design requirements to provide a product that will delight the using customer. Approximately 150 BTU of heat energy are required to melt 1 pound of ice at 0° F. This assumes no loss of BTUs during transfer to the ice, and such 100% efficiency is not possible with ordinary spray jets in actual practice of melting ice on a windshield since most of the heat is lost due to wind/air velocity chill evaporation while transiting from the nozzles to the windshield, as is indicated by commonly visible heated washer condensed steam vapors in the cold air before contacting the windshield. As a standard reference point there is approximately 1 pound of frost/ice at 0° F. specified to be on the windshield in U.S. Federal Motor Vehicle Safety Standard 103 (FMVSS103) for automotive vehicle defrosting performance validation testing. European defrosting safety standard specifications are similarly written. The critical central vision area (designated as area “C” in FMVSS103) of the windshield needs to be cleared within 30 minutes in order for the vehicle to be legally sellable. Typical vehicles with conventional warm air defrosters (basically 75+ year old defroster technology) clear this “C” area in about 17 minutes from the FMVSS103 validation test temperature of 0° F. cold engine, cold vehicle start. This seemingly excessive amount of time allowance indicates the ineffectiveness of conventional warm air defrosters and does not bode well for upcoming crash avoidance and pedestrian protection ratings. Furthermore, there is less coolant waste energy becoming available for defrosters because of ever more fuel efficient power plants. The need for a much quicker acting and therefore safer and more satisfactory defrosting technology has become even more obvious.

Putting windshield defrosting energy and efficiency requirement into further perspective is to realize that 1 BTU equals about 1000 watt seconds of energy. So to provide the 150 BTUs to melt 1 pound of ice requires 2.5 minutes of a heater generating 1000 watts, or alternatively, 3000 watts of heating power for 50 seconds, or again, alternatively, 5000 watts for 30 seconds. Fortunately, complete ice and frost melting is not necessary since partial melting in combination with wiper blade action to wipe away loose slush can effectively provide quick deicing for good windshield visibility, and wiper action is allowed, but rarely used, in FMVSS103 testing but, of course, is still legally viable to use in any case. It follows that it would be very desirable to design an automotive washer fluid heater system capable of 3000 watts, and up to even 5000 watts for large windshields, so as to have good capability of typically melting and wiping away substantial windshield frost/ice within, say, 30 seconds, of cold engine start and be assured the washer nozzles will not freeze shut.

A fundamental technical requirement of designing a high power washer heater is to determine a “vehicle lifetime” electrical switch that will be highly durable and reliable for the high current needed. It should be better than traditional automotive solenoid operated contactor switches used to start ICEs since they historically commonly burn out in starter motors during the normal life of the vehicle, and will be more prone to failure with the advent of “stop start” systems which will increase engine lifetime starts from about 25000 to 250000. These switches do not have the inherent reliability and durability, or even cost effectiveness, desired for a high power electric windshield washer fluid heater. Solenoid magnetic coils commonly burn out, and electrical contacts stop working from repeated high current “make/break” starter motor inductive arcing resulting in oxidation contamination, cratering, “whiskering”, and subsequent contact overheating. Contact overheating from subsequent increase in “IR drop” heating will even cause conventional contactors to fail in a welded state which can result in runaway heat generation and battery drain.

Solid state electronic switches, such as high amperage insulated gate bipolar transistors (IGBTs) and metal oxide semiconductor field effect transistors (MOSFETs), which have no moving contact parts, are a consideration for a switching device of the present invention but these are known to be excessively costly for most automotive uses and don't offer very good high amperage capable characteristics for the low voltage, e.g. 12 volt, systems for the majority of vehicles produced in the foreseeable future. These switch types conventionally require complementing componentry such as smaller relays and additional control electronics and wire harnesses which add cost, and the added complexity tends to reduce reliability. In the more distant future these might become economically viable and capable to use for switching the high power for the invention herein for voltages and amperages then to be commonly used. This could be achieved simply by having the contacts of the present invention serve as a low current fluid flow sensing trigger, or having a Hall sensor or magnetic reed switch detect the threshold piston movement flow sensing and thereby trigger solid state high heating power switching.

Fortunately, as will be seen in the forthcoming invention description, a strong and reliable switch activating force will be derived simply from the differential fluid flow pressure within the heater itself; negating the need for a solenoid generated switching force.

The invention will also be shown to incorporate a novel strong deactivating switch force mechanism derived from a discharging liquid accumulator upon washer pump turn off. It is well known to those skilled in the art of high power switch design that a strong fast switch opening “break” will minimize contacts arcing distress and separate any possible welding of the contacts that would otherwise continue to draw high power causing a thermal event or battery run down.

In addition to the above mentioned rapid circuit break feature, successful contact make, is ensured by an exceptionally strong differential pressure piston induced closing force in the highly arc resistant, highly non-oxidizing and hermetically sealed media construction with adjoining heat sinking electrodes, all in combination as believed by the inventor, not to be found in automotive use.

Along with providing a washer heater having much greater electric heating power to improve safe driving visibility is the need to assuredly and safely prevent overheating of the heater, guarding against any general damage to the vehicle and ensuring a fully functional washer system including preventing nozzle freeze up. In case an inadvertent excessive thermal event does occur in the present invention, multiple fail safe startup and shutdown features will become evident as fully reliable protection to the vehicle in the invention summary and description to follow.

In order to obtain the commonly desired heated windshield washer fluid “instantly”, i.e. within a very short time of starting a cold engine, there have been a number of previously proposed heaters for windshield washer fluids which utilize an electrically heated element to heat the windshield washer fluid. These previously known electrically heated windshield washer fluid systems, however, have not proven successful for a number of reasons.

First, these previously known electrically heated systems were prone to failure and even caused smoke and fire due to shorting out and otherwise overheating. Fires within the engine compartment, of course, are completely unacceptable.

Failure from weak antifreeze washer fluid and subsequent inadvertent fluid freeze expansion within the heater has also been a cause of washer heater commercial failure. Advantageously, it is inherent in the present invention's unique thin flow channel fluid heat transfer configuration concept to also protect against heater freeze damage.

A further disadvantage of these previously known proposed windshield heated washer systems which used electric heaters to heat the windshield washer fluid is that such proposals did not provide a dedicated design feature to prevent nozzle freeze up and were overly complex and expensive to manufacture. In the highly competitive automotive industry, the addition of even a few dollars of additional cost to an automotive vehicle is considered significant.

Vehicle weight reduction (“light weighting”, as it is now called in the industry) is playing much more of a key role in achieving the upcoming very aggressive fuel economy regulations, re. 54.5 miles per gallon CAFÉ regulated requirement effective year 2025. It is not unusual for newly designed vehicles to be in jeopardy of exceeding CAFÉ (Corporate Average Fuel Economy) weight dependent requirements, thereby facing significant economic penalty in order for the vehicle to be legally sellable. Indeed, cases can develop whereby reducing a particular vehicle's design weight can be worth many dollars per pound per car produced. This translates to many millions of dollars of cost avoidance and preserving many millions of dollars of needed automaker profits to stay in business. Cars and light trucks typically carry about 8 pounds of washer fluid with a full reservoir. Most washer fluid sales are in the winter, which, in itself strongly suggests the need for a more effective washer fluid heater for deicing so as to use less washer fluid for clearing windshield frost, ice, and road grime. So-called “deicing” washer fluids are popular, and costly at commonly around $5.00/gallon, but have limited effectiveness, particularly with their higher alcohol content in colder temperatures when they become slow to flow from increased viscosity and need a goodly amount of heat to work well, just as similar fluids are used in a heated state, for deicing aircraft prior to departure. A highly effective heated washer system can not only provide for accident avoidance, pedestrian protection, and a happier driver but can potentially reduce washer fluid weight of the vehicle by 50% (4 pounds indicated here) and relieve corresponding packaging space because a much smaller reservoir can be used since less fluid is needed per windshield clearing cycle. Such weight reduction technology can significantly offset the actual cost of the added heated washer feature because of the otherwise fuel economy economic penalties, sometimes called “gas guzzler tax”, to the automakers.

A novel solution to the vexing problem of freezing washer nozzles is offered by the present invention. Of course freezing nozzles render the windshield washer system non-functional often resulting in exceedingly unsafe driving visibility, particularly at night.

The only well-known solution to washer nozzle freezing of which the present inventor is aware is an electrically heated washer nozzle system. These are so costly and complex that a very low percentage of vehicles incorporate it in North America. However, European pollution standards are more restrictive on the amount of alcohol antifreeze in windshield washer fluid and there is a strong tendency for freezing at the nozzle opening where the local alcohol easily evaporates resulting in freeze up. Therefore a high percentage of vehicles in Europe utilize costly electrically heated nozzle systems.

As will be shown, after the driver uses the heated washer system of the present invention, the phenomenon of the washer heater accumulator chamber cooling down, after heating the washer fluid, will cause condensation and contraction of the washer fluid alcohol/water vapors in the accumulator chamber thereby causing a partial vacuum resulting in the fluid at the nozzles being withdrawn well back into its hose lines so as to be virtually impervious to evaporation of the alcohol in the fluid. This alcohol evaporation at the nozzles is widely believed to be the most common cause of nozzles freezing shut. With the present invention the nozzle openings will be highly resistant to freezing shut since the washer fluid will be withdrawn back into the fluid feed lines, and even into the warmer engine compartment if desired.

### SUMMARY OF THE PRESENT INVENTION

The present invention provides a heater for windshield washer fluid for an automotive vehicle which overcomes all of the known disadvantages of the previously known automotive electric washer fluid heaters and further provides the extraordinary advantages of truly rapid defrosting, nozzle freeze protection, exceptionally high design reliability, much higher heating power, unusual simplicity, light weighting, and cost effectiveness.

The present invention comprises an elongated housing which is generally tubular and cylindrical in shape. A windshield washer fluid inlet is open to one end of the housing and, similarly, a windshield washer fluid outlet is connected to the opposite end of the housing. A cylindrical housing chamber is formed between the ends of the housing.

A cylindrical piston is mounted within the housing chamber and movable axially within the housing chamber by a relatively small distance, e.g. a few millimeters. The piston itself is cylindrical thus forming an annular chamber between the piston and the housing. This annular electric heat transfer chamber, which can inadvertently freeze solid and expand damagingly because of insufficient washer fluid alcohol antifreeze content, and remaining potential fluid freezing non-heated chambers, preferably have a wetted surface area to volume ratio in excess of 500 meters²/meters³ to guard against inadvertent freezing ice expansion damage. The thin annular chamber also provides for an exceptionally thin heat transfer fluid boundary layer which is approximately ⅓^{rd} of the annular chamber thickness, and therefore provides for highly efficient heat transfer into the annular fluid flowing chamber and highly effective cooling of the heating element. Furthermore, the annular chamber formed between the piston and the housing fluidly connects the windshield washer fluid inlet to the windshield washer fluid outlet. The piston is hollow, with a dual purpose passage for fluid to enter and exit, and contains gas, and fluid, sometimes below atmospheric pressure for the first purpose of withdrawing fluid from nozzles preventing nozzle freeze up upon cool down. The second purpose hollow piston and flow passage serves as a quick discharging accumulator to ensure a rapid break of the electric contacts immediately after washer pump shut down.

A sheet of electrical resistance heating element, such as nichrome, is wrapped around at least a portion of the housing so that the sheet extends between the ends of the housing. This heating element is in turn covered by a cylindrical clamshell cover, and possibly a thin film of high temperature insulation, both of which are fire resistant in the event of overheating of the heating element, to hold the heating element, preferably in metallic foil form, in intimate contact with the hard coat anodized aluminum housing, or insulation, as the case might be, around which the foil is closely wrapped. A wire or ribbon wound heating element, which would tend to be highly inductive, is avoided so as to prevent excessive inductive current contact arcing occurring upon contacts breaking the circuit, and the accompanying electromagnetic field disturbances caused by a high inductance heating element.

One end of the heating element, preferably the end adjacent the inlet end to the housing, is connected to the automotive vehicle electrical ground. The opposite end of the heating element is connected through a switch to the positive terminal of the vehicle battery. Consequently, when the switch is closed, electrical current runs through the heating element thus heating not only the heating element, but also heating through the housing to the annular chamber containing the flowing windshield washer fluid. During actual washer fluid heating operation, in order to protect against full film boiling and overheating the heating element and other components in proximity, the heating element heat transfer to the annular chamber is to be less than 1000 watts per square inch, and preferably less than 250 watts per square inch average over the total heating area of the heating element during the windshield washing cycle time, and concurrent washer fluid flow is to be greater than 0.10 ounces per second.

In the preferred embodiment of the invention, a simple high amperage contact switch is provided between the positive battery terminal and the heating element. The piston, when in a retracted position, and in combination with the contact opening force of the contactor leaf spring and compressed elastomer seal, provide for the contact static open position. Conversely, upon the washer fluid pump generating a threshold amount of differential pressure of flowing fluid across the piston, the piston within the housing shifts to an extended position thus deflecting the switch contact, which is electrically conductive with the contactor leaf spring to the heating element in series to battery ground terminal, to the stationary contact connected to the battery positive terminal. When in this position, the switch is closed thus providing electrical power to the heater element and conductively heats the flowing fluid through the heat conducting electrically insulated anodized aluminum outer housing. Consequently, the heater element is only powered when the washer fluid pump is also powered and a calibrated threshold amount of fluid is flowing with high enough differential pressure and flow to keep the contacts closed and the heating element at a safe temperature, i.e. during a windshield spraying operation. As such, the heater functions with good convenience to the driver by only having to activate the conventional washer switch in the customary manner. There is no other cabin operated “selective” switch or control knob which can distract the driver and cause dashboard or steering column clutter, as has been needed with previously known electric windshield washer heaters or other defrosting systems such as electrically heated windshields, and even conventional warm air defrosters.

Note that in the inadvertent case of no flow or low flow, for example, nozzle freezing, or a pinched washer feed hose and when reservoir fluid is adequate and the washer pump is turned on, there will still be a static pressure difference between the piston and the smaller diameter switch plunger portion, which is also exposed to outside atmospheric pressure, producing a relatively small force tending to close the contacts and cause overheating for lack of flowing fluid. However the countering return switch leaf spring and seal opening forces will be enough to prevent the contacts from closing and turning on the heater. Only with the addition of sufficient differential pressure from actual flow across the piston will the overall pressure be sufficient to overcome the leaf spring and seal return forces and close the contacts and power the heating element. Therefore, in the event of washer nozzle ice, debris, pinched hose, empty reservoir, or otherwise cause of inadequate flow, the resulting low or absent differential pressure across the piston will prevent the heater from activating thereby preventing the heater from overheat failure.

Even in the event of some unanticipated occurrence of heater element moderate overheating, the highly heat resistant insulating covering will protect close-by components from heat damage. Also, in the case of any possible inadvertent more extreme heater element over temperature, multiple redundant fusing connections to the heater element will melt at relatively low temperature, e.g. 400° F. to 600° F. solder melting temperature, which will be below the short term damaging temperature of nearby materials, thereby opening the circuit and permanently preventing the heater from heating. In any case, upon permanent shutdown of the heater element, the only adverse effect is that the washer fluid passing through the housing will no longer be heated and a simple procedural heater replacement will be in order to regain the heating function.

It might be desirable to keep the heating element turned off during non-freezing weather, or when the vehicle is also equipped with an ICE coolant powered washer heater and after the engine has warmed so as to draw electric heating power only when the need is great enough. To achieve this in such cases a coolant temperature sensor and/or outside ambient temperature sensor is to be employed with the present invention in combination with higher output fluid supply for freezing temperatures and a lower output fluid supply for warmer non-freezing conditions. In the lower fluid output supply warm weather mode there will not be sufficient differential pressure across the piston to close the heater switch, and in the higher output fluid supply cold weather pumping mode there will be sufficient differential pressure across the piston to close the heater switch. Such a dual fluid flow rate configuration can be constructed simply by a circuit having a series dropping resistor to the pump and a parallel circuit bypassing the dropping resistor consisting of said temperature sensor switch to provide a “zero resistance full power” electrical path to the pump motor. Alternatively, an alternate restriction flow path thermostatic valve construction can be incorporated to achieve both “summer/lowered flow” and “winter/increased flow” fluid flow paths. It is noted that existing washer pumps are generally more powerful than needed in warm weather so that output at subfreezing temperatures with associated higher viscosity alcohol containing fluid can usually be adequate. It is also noted that excellent washer flow at extreme low temperature such at −40° is provided by well heated washer fluid as is be provided by the present invention.

Another activation control configuration for dual flow rate for the washer heater, and which could be more appropriate for an aftermarket/retrofit installation, is to have a washer fluid/pump pressure signal switch in electrical series with an engine coolant and/or ambient temperature sensing switch to activate an add-on booster washer pump, in hydraulic series with the OEM pump for operation below freezing temperature. The resultant increase in differential pressure across the piston would then generate enough force to close the piston contacts for the heating element current.

In order to provide desired uneven heating along the entire length of the heater element, preferably the resistance of the heater element generally decreases along its length as heated fluid nears the heater outlet. This can be accomplished by perforation holes of varying size and pattern density in the heater element to thereby adjust the resistance of the heater element along its length, or varying the thickness of the heater element foil along the axis of the heater, thinner at the cold fluid inlet end to provide highest rate of heating for the cold fluid, and thickest at the heated fluid outlet end to provide lowest heating rate. This variable heating rate is in order to prevent full film boiling toward the outlet end and subsequent loss of heat transfer that could cause the heater element to overheat and prematurely melt the failsafe fuse connections. Advantageously, it also provides for the shortest packaging length for a given heater power rating.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a diagrammatic view of a windshield wiper system;

FIG. 2 is a longitudinal sectional view illustrating the heater of the present invention during a windshield wiper spraying operation when the windshield washer pump is deactivated;

FIG. 3A is a fragmentary sectional view illustrating the heater when the windshield washer fluid pump is activated;

FIG. 3B is a view similar to FIG. 3A, but illustrating the opposite end of the heater, and

FIG. 4 is a view illustrating the heater element in an unwrapped condition.

### DETAILED DESCRIPTION OF A PREFERRED EMBODIMENT OF THE PRESENT INVENTION

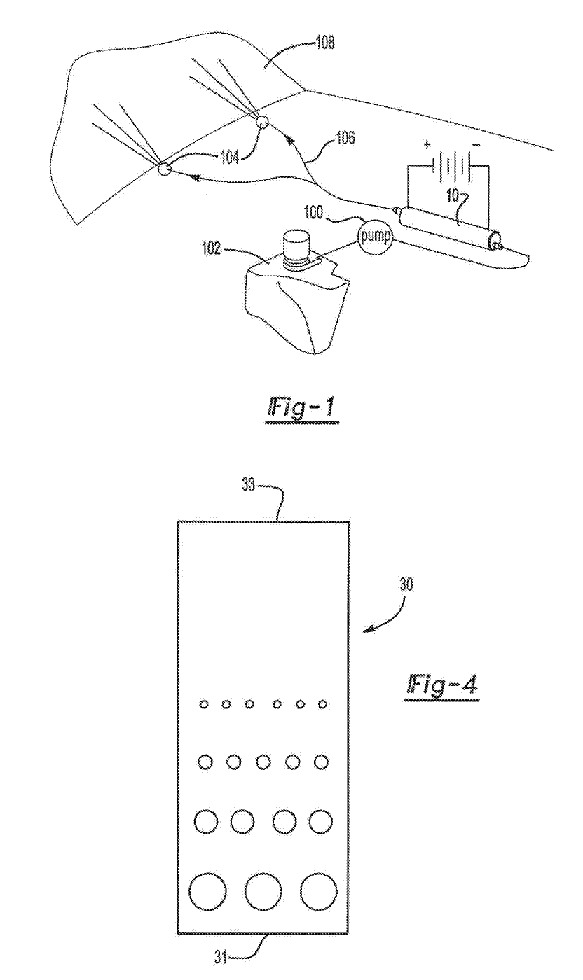

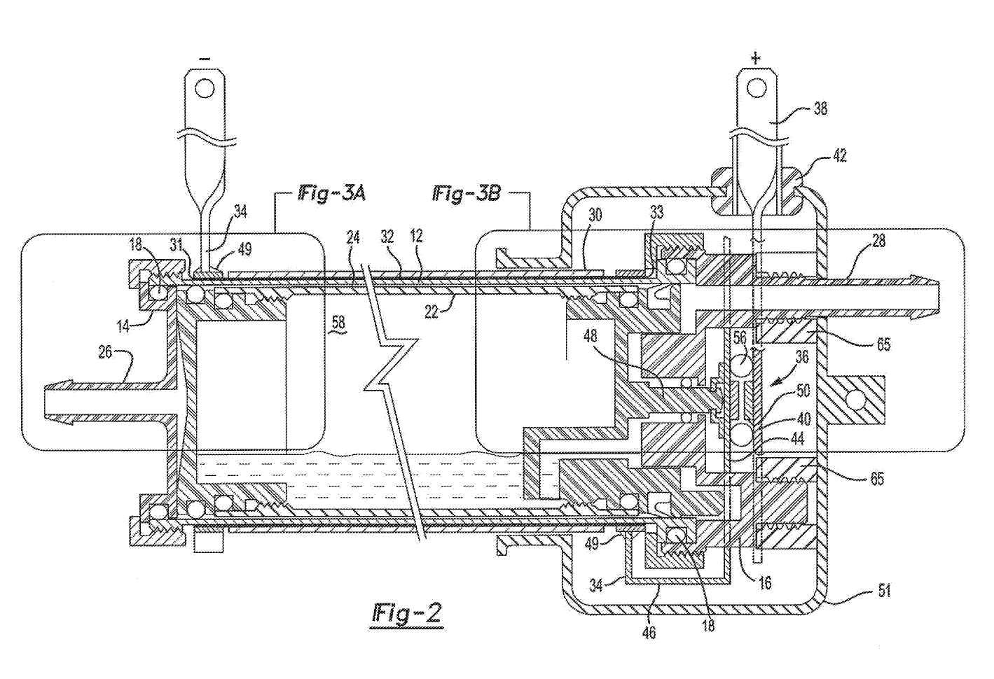

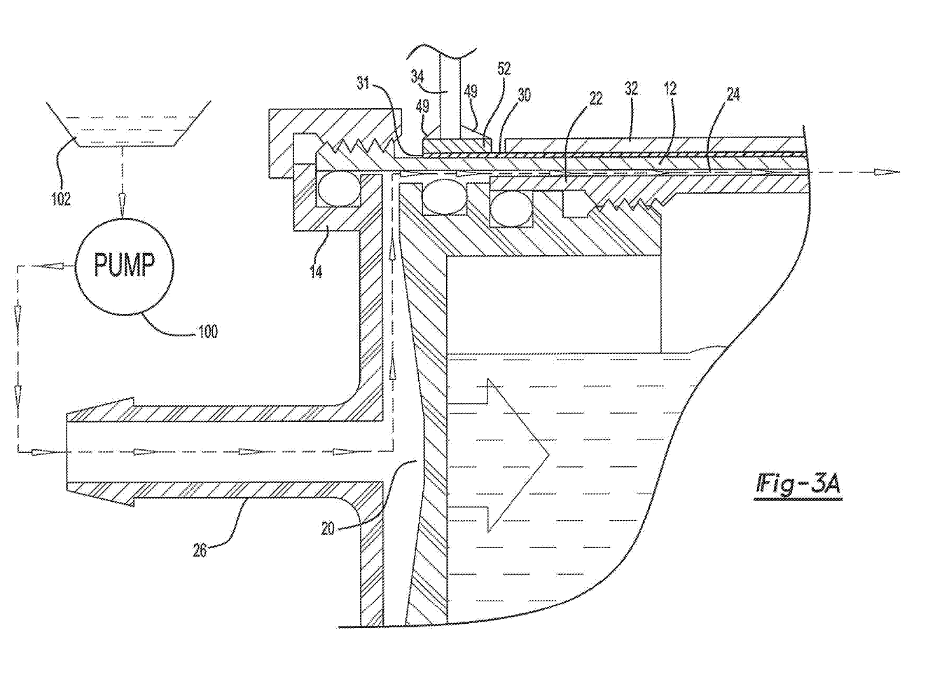

With reference first to FIG. 1, a preferred embodiment of a windshield wiper fluid heater 10 according to the present invention is shown. The heater 10 is fluidly connected in series between a windshield wiper fluid pump 100 having its inlet connected to a windshield wiper fluid reservoir 102 and wiper fluid nozzles 104 (or other outlets for the windshield wiper fluid). 108 is the windshield. As best shown in FIGS. 2, 3A, and 3B, the heater 10 includes a tubular and cylindrical housing 12 made of preferably electrically insulating, but highly heat conductive material such as hard coat anodized aluminum. A first end cap 14 closes one end of the housing 12 while a second end cap 16 closes the opposite end of the housing 12. Both end caps 14 and 16 are preferably made of plastic and are sealed to the housing 12 in any appropriate fashion, such as by seals 18. In doing so, the housing forms a cylindrical housing chamber 20.

A cylindrical piston 22 is axially slidably mounted within the housing chamber 20 and movable between a retracted position, illustrated in FIG. 2, and an extended position, illustrated in FIGS. 3A and 3B. The piston 22, furthermore, is dimensioned to form a thin annular heat transfer fluid chamber 24 in between the piston 22 and the housing 12. This annular heat transfer chamber 24 preferably has a wetted surface area to volume ratio in excess of 500 meters²/meters³. This annular chamber 24, furthermore, is open to the housing chamber 20.

A windshield washer fluid inlet 26 is either attached to the end cap 14 or formed as a part of the end cap 14. Similarly, a fluid outlet 28 is either attached to or formed as a part of the end cap 16. The fluid inlets 26 and 28 are both open to the housing chamber 20 and thus open to opposite ends of the annular fluid chamber 24.

Both the inlet 26 and outlet 28 are in the form of a fluid nipple and adapted for connection with a fluid coupling, such as an elastomeric connector. The inlet 26 is connected to the outlet from the windshield washer fluid pump 100 while the outlet 28 is connected via tubing 106 which preferably is of vapor barrier construction such as nylon to minimize freeze up in the tubing (FIG. 1) to spray jet nozzles 104 aimed at a windshield 108 of a vehicle.

Still referring to FIGS. 2, 3A, and 3B, a heating element 30, such as a sheet of nichrome metal foil, is wrapped around the housing 12 between the ends of the housing 12. This heating element 30 in turn is covered by a highly heat resistant non-electrically conductive cover 32, such as hard coat anodized aluminum, which may be also thermally insulated on its interior, by a high temperature material such as a 0.010 inch thick silicone rubber film (not shown) and which extends substantially along the entire length of the housing 12. The cover 32 also serves to hold the heating element 30 in intimate contact with heater housing 12 to ensure good heat transfer to the housing 12.

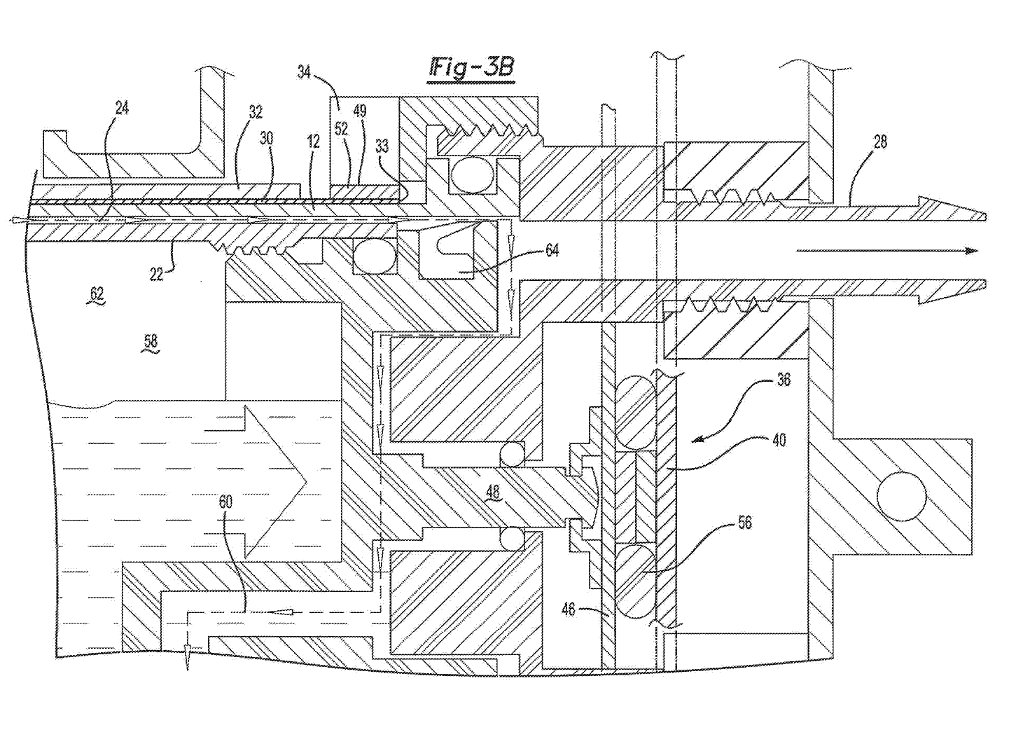

As shown in FIG. 4, the heater element 30 preferably has increasing resistance from its end 31 to its opposite end 33 so cold entering fluid by element end 31 is heated at a high rate and subsequently heated at a reduced heating rate as the flowing fluid approaches the highest fluid temperature at the heater outlet by element end 33. This is to help keep washer fluid below what is called the “full film boiling zone” in which the substantial deterioration of the heat transfer coefficient at the inner wall of the housing 12 would prevent the heating element 33 and housing 12 from being adequately cooled and the unwanted temperature rise could particularly cause the fuse joint 49 to prematurely melt and permanently terminate the heating function. Alternatively, an electronically controlled heater temperature sensor system could be constructed to automatically switch on and off the heater to help guard against overheating, but this is inherently a more complex costly system and would tend to provide little reliability improvement. While fluid is flowing through the annular chamber 24 the decreasing resistance of the heating element ensures an uneven heating rate of the windshield washer fluid as its temperature rises toward its boiling point near the fluid outlet end 28 of the heater. This feature of decreasing wattage per lineal distance of heating provides for a maximum overall wattage of the heater for a given heater package size and weight, thereby minimizing space and weight required for installation in crowded modern automotive engine compartments.

The end 31 of the heater element 30 is connected with the solder fuse joint 49, with the aid of clamping ring 52, to an electrical lead 34 which, in turn, is connected to the ground or negative battery terminal of an automotive vehicle. The opposite end 33 of the heating element 30 is electrically connected, with the aid of clamping ring 52 on solder fuse joint 49 to a switch 36, to electrical lead 38 which is electrically connected to the positive terminal of the battery for the automotive vehicle.

With reference to FIGS. 2 and 3B, the switch 36 includes a stationary electrode 40 which is attached to the housing 12 in any conventional fashion, such as fastener nuts 65 and grommet 42. The electrode 40 is part of the electrical lead 38 connected to the positive terminal of the automotive battery. The switch 36 also includes a symmetrical flexible bridging leaf spring electrode 44 which is electrically connected at two fusing solder joints 49 onto clamp ring 52 on the outlet end to the end of the heater element 30 adjacent the fluid outlet 28.

Whenever the windshield washer fluid pump is deactivated, the leaf spring 46 retracts to its original position shown in FIG. 2 in which there is a gap between the electrodes 40 and 44. When the windshield washer fluid heater 10 is deactivated, the spring 46 is captured by its connecting clip to plunger 48 attached to the piston 22 and rapidly retracts the piston, to minimize electrical arcing upon breaking the contact, 22 to its retracted position illustrated in FIG. 2. The rapidity of the retraction is enhanced by the pressurized fluid inside the hollow piston ejecting through passage 60.

Upon activation of the windshield washer fluid pump 100, the pump 100 provides pressurized fluid into the inlet 26. Assuming a threshold amount of fluid flow results in differential pressure across the piston 22 to overcome the opposing spring force of electrode spring 46 and elastomer seal 56, this differential pressure acts against the piston 22 thus moving the piston 22 to its extended position as illustrated in FIGS. 3A and 3B. Upon doing so, the piston plunger 48 deflects the electrode 46 into the electrode 40 thus completing the electrical circuit between the battery lead 38 and the heater element 30. The switch 36 will remain in a closed position as long as the washer fluid pump 100 is activated and there is sufficient differential flow pressure across the piston 22. Upon deactivation of the windshield washer fluid pump 100, the spring 46 and elastomer seal 56 act against the piston plunger 48 to return the piston plunger 48 and piston 22 to its retracted position shown in FIG. 2 in which the switch 36 is electrically open.

In the event the vehicle system voltage becomes too low during heater operation, a resulting differential pressure drop will occur which opens switch 36 and provides protection against excessive battery drain.

In case of inadvertent excessive overheating of the heating element solder fuse joints 49 serve to melt at a low enough temperature and permanently open the heating circuit so as to prevent heat damage to any nearby components.

In order to minimize arcing between the electrodes 40 and 44 during opening and closure, preferably an arc quenching and contact protective media is provided in the flexibly sealed resilient contact chamber 50 between the two electrodes 40 and 44. If a vacuum media is used the chamber seal can have flexible lips configured such that the flexible chamber housing becomes a vacuum pump whenever there is contact motion. Alternatively, a separate air check valve can be incorporated to the chamber to achieve a self-sustaining vacuum. This self-sustaining vacuum system will ensure the contacts operate in a clean anti-corrosive, anti-erosive arc quenching vacuum media. Also alternatively, a vacuum line from the vehicle vacuum system could be connected to the contact chamber 50.

In order to further minimize arcing during opening and closing of the switch 36, a sealing elastomeric O-ring 56 is preferably positioned around the switch contacts. The O-ring 56 is selected so that, upon activation of the pump 100, the O-ring 56 compresses and allows switch closure as shown in FIG. 3B. However, upon deactivation of the pump 100, the O-ring 56 decompresses thus providing rapid opening of the switch 56 thereby minimizing arcing.

In order to further increase the opening speed of the switch 36 upon deactivation of the pump 100, the piston 22 preferably has a hollow interior chamber 58 fluidly connected to the outlet 28 by a fluid conduit 60. Upon initial activation of the pump 100, the piston chamber 58 will only partially fill with windshield wiper fluid thus entrapping an air pocket 62 in the piston chamber 58. Thereafter, during activation of the pump 100, the pump 100 provides pressurized fluid to the outlet 28 and thus to the piston chamber 58. This pressure, in turn, pressurizes the air pocket 62 to 20 psi for example. Consequently, upon deactivation of the pump 100, pressurized fluid from the piston chamber 58 flows back to the outlet 28 thus urging the piston 22 towards its retracted position and increasing the opening speed of the switch 36.

With reference to FIG. 3B an annular cup seal 64 preferably seals one end of the piston 22 to the interior of the housing 12 to act as a nozzle anti drain back valve and to enhance ejection jet reaction from the hollow piston accumulator for more speedy contact breaking. Upon activation of the pump 100, the cup seal 64 collapses as shown in phantom line to permit fluid from the annular chamber 24 to flow past the cup seal 64 to the outlet 28. However, upon deactivation of the pump 100, the cup seal 64 returns to its non-collapsed position shown in solid line thus sealing the piston 22 to the housing 12 thus eliminating back flow and thereby enhancing hollow piston fluid ejection jetting reaction to quickly open the contacts. Upon a subsequent activation of the pump 100, fluid is almost instantaneously sprayed from the nozzles 104 without the common practice of providing one way check valves integral to the nozzles or in line with the conduits to the nozzles 106.

A prime advantage of the present invention is that the electrical switch 36 will remain in a closed position thus providing power to the electrical heating element 30 only while a threshold amount of windshield washer fluid is flowing from the inlet 26 and to the outlet 28. That fluid flow through the annular chamber 24 and closely adjacent the heating element 30 ensures that the heating element will remain relatively cool during operation thus preventing failure, and even subsequent fire occurring from the heating element 30 overheating. However, even in the event of actual overheating failure, fuse joints 49 and cover 32 effectively prevent damage to other vehicle components in the engine compartment, yet the unit still remains functional as a washer fluid conduit, albeit unheated.

In the present invention, even though overheating failure effects surrounding the heating element have been thoroughly considered and design safety measures provided accordingly, another mode of overheating failure is taken into account that is more subtle and has caused commercial failure of previous automotive electric washer fluid heaters. That is the failure mode of unfused “weak” short circuiting. This can happen simply by having insufficient clearance between current carrying items and surface contaminated components having increasing surface connectivity to positive and grounding circuits and not providing a clean atmosphere for the switch mechanism and adequate conductive corrosion and mineral trace and condensation protection. Switch cover 51 (FIG. 2), elimination of potential corrosion and corrosion trace areas, and maintaining safe separation and electrical insulation between positive and negative circuits have accordingly been incorporated into this invention.

Another prime advantage of the present invention is nozzle freeze protection. This is achieved by the alcohol containing antifreeze washer fluid vapors cooling and condensing within the hollow piston chamber after heater shut down resulting in a partial vacuum and thereby withdrawing fluid substantially away from the nozzle openings, back into the fluid conduits. Since the nozzles are then purged of washer fluid at the nozzle openings where the alcohol can easily evaporate there is much less probability of the nozzles freezing shut and preventing washer system operation. Such freeze up is of course very dangerous because of the resulting poor windshield visibility. This freeze up protection now offers a new opportunity for automotive styling designers to remove unsightly non-electrically heated nozzles on top of the hood and locate them in the preferred state of the art “out of sight underneath rear edge of the hood, and closer to the windshield” location. Mounting the nozzles on top of the hood has been a long standing practice to give a better chance of unfreezing frozen nozzles by exposure to rising engine heat.

Having described my invention, many modifications will become apparent to those skilled in the art to which it pertains without deviation from the spirit of the invention as defined by the scope of the appended claims.

I claim:

1. A heater for windshield washer fluid comprising:
an elongated housing having an interior chamber, a fluid inlet open to one end of said housing and a fluid outlet open to a second end of said housing,
a piston positioned in said chamber and movable between said ends of said housing between a retracted position in which one end of said piston is closely adjacent said fluid inlet and an extended position in which said one end of said piston is spaced from said fluid inlet,
said piston forming an annular chamber between piston and said housing which fluidly connects said fluid inlet to said fluid outlet,
an electrical heating element disposed around a portion of said housing,
an electrical switch mounted to said housing at said second end of said housing and electrically connected to said heating element,
a switch actuator mounted to said second and of said piston which actuates said switch when said piston is in said extended position.

2. The heater as defined in claim 1 and comprising a spring which urges said piston towards said retracted position.

3. The heater as defined in claim 2 wherein said switch comprises a pair of spaced apart electrical contacts and wherein said spring comprises a resilient member positioned between a portion of said electrical contacts.

4. The heater as defined in claim 1 wherein said heating element comprises a heating foil wrapped around said housing.

5. The heater as defined in claim 4 wherein one end of said foil is connected to said switch and the other end of said foil is connected to an electrical voltage source or ground, said switch being electrically connected to the other of said electrical voltage source or ground.

6. The heater as defined in claim 5 wherein said foil is formed to provide variable heating along its length.

7. The heater as defined in claim 6 wherein said foil has a plurality of holes formed through it to vary the heating capacity of the foil along its length.

8. The heater as defined in claim 6 wherein said foil has a varying thickness along its length.

9. The heater as defined in claim 1 and comprising a one-way valve in said housing mounted in series with said annular passageway to enable fluid flow only from said inlet to said outlet.

10. The heater as defined in claim 9 wherein said valve comprises a resilient cup seal disposed in series with said annular passageway.

11. The heater as defined in claim 1 wherein said piston includes an internal chamber and a fluid conduit which fluidly connects said internal chamber with said fluid outlet.

12. The heater as defined in claim 11 and comprising a one-way valve fluidly positioned upstream from said outlet so that said piston internal chamber remains fluidly connected to said fluid outlet in the absence of fluid flow from said inlet to said outlet.

13. The heater as defined in claim 1 wherein said annular chamber has a wetted surface greater than 500 meters²/meters³.

14. The heater as defined in claim 1 wherein said housing is constructed of metal with an anodized outer surface.

15. The heater as defined in claim 14 wherein said metal comprises aluminum.
